(19) United States
(12) Patent Application Publication
(10) Pub. No.: US 2012/0297852 A1
(43) Pub. Date: Nov. 29, 2012

(54) METHOD FOR MANUFACTURING TERMINALS HAVING PRESS-FIT ENGAGING PARTS

(75) Inventor: Nobuyuki Sakamoto, Makinohara-shi (JP)

(73) Assignee: YAZAKI CORPORATION, Tokyo (JP)

(21) Appl. No.: 13/576,704

(22) PCT Filed: Feb. 3, 2011
(86) PCT No.: PCT/JP2011/052296

§ 371 Date: Aug. 2, 2012

(30) Foreign Application Priority Data
Feb. 3, 2010 (JP) 2010-022435

(51) Int. Cl. H01R 43/16

(52) U.S. Cl. 72/339

(57) ABSTRACT

A method for manufacturing terminals is provided which can form press-fit engaging parts that can secure a necessary holding force without being affected by a clearance between terminals.

The method for manufacturing terminals includes a first step in which a plurality of terminals (20) arranged in parallel to each other at a prescribed interval laterally in a row, while connected to a carrier (11), are collectively molded by press punching a sheet metal, and a second step after the first step in which press-fit engaging parts (22), which prevent the terminals from being pulling out when the terminals are press-fitted into press-fitting holes of a connector housing, are formed by applying a crushing pressure in a vertical direction that is perpendicular to the direction of arranging the terminals, onto prescribed parts in the longitudinal direction of the terminals, and making parts at the side surfaces of the terminals to be locally and convexly bulged sidewards.

### TECHNICAL FIELD

The invention is related to a method for manufacturing terminals which have press-fit engaging parts that prevent the terminals from being pulling out when the terminals are press-fitted into press-fitting holes of a connector housing.

### BACKGROUND ART

A connector for circuit boards is often manufactured, for example, by press-fitting a plurality of terminals into press-fitting holes of a connector housing from back while the plurality of terminals are connected to a carrier, and cutting the carrier after the press-fitting. It is common that the plurality of terminals used in this kind of connector are molded collectively for each carrier by press punching one piece of sheet metal.

FIG. 14 shows a molded article of a group of such molded terminals (for example, refer to a PTL 1). In the molded article, a plurality of terminals 210 are arranged in parallel to each other at a prescribed interval lateral in a row, and each of the base ends of the terminals 210 is connected to a carrier 200. Each of the terminal 210 has an electrical contact part 211, which electrically contacts with a mating connector terminal, at the front of the terminal 210, a press-fit engaging part 212 behind the electrical contact part 211, and a hind leg 213, which extends from the rear of a connector housing when the terminal 210 is installed into the connector housing, behind the press-fit engaging part 212. The press-fit engaging part 212 includes punched parts 215 and 216 which are formed by make parts at the sides of the terminal 210 to become locally convex at the time of press punching.

### CITATION LIST

### Patent Literature

[PTL 1] JP-A-2004-63101

### SUMMARY OF INVENTION

### Technical Problem

Recently, a demand of making the pitch between terminals as narrow as possible has become strong due to the downsizing of the connector. However, when the terminals 210 are collectively molded by press punching while the terminals 210 are connected with the carrier 200 as mentioned above, it is required to secure a clearance between adjacent terminals 210. But when the pitch between terminals 210 becomes narrow, it becomes impossible to fabricate the press-fit engaging parts 212 that have a sufficient form to be projected towards the clearance side. That is, it is impossible to fabricate the press-fit engaging parts with a sufficient projection margin to secure a holding force required at the time of press-fitting. Therefore, there is a problem that the shortening of the terminal pitch is restricted by the width of the press-fit engaging parts 212.

In view of the above situation, the invention is intended to provide a method for manufacturing terminals which can form press-fit engaging parts that can secure a necessary holding force without being affected by a clearance between terminals.

### Solution to Problem

In order to solve the above technical problem, according to a first invention, there is provided a method for manufacturing terminals which have press-fit engaging parts, comprising:

a first step for collectively forming a plurality of terminals arranged in parallel to each other at an interval laterally in a row in a state connected to a carrier, by press punching a sheet metal; and

a second step for forming the press-fit engaging parts after the first step, by applying crushing pressure in a vertical direction that is perpendicular to an arranging direction of the terminals and a longitudinal direction of the terminals, onto prescribed parts in the longitudinal direction of the terminals so as to make a part of a side surface of each of the terminals to be locally and convexly bulged in at least one direction of side direction and up and down direction, wherein the press-fit engaging parts prevent the terminals from being pulling out when the terminals are press-fitted into press-fitting holes of a connector housing.

According to a second invention, there is provided the method for manufacturing the terminals which have the press-fit engaging parts according to the first invention, wherein

two convex bulged parts are formed in a row in the longitudinal direction of the terminals as the press-fit engaging parts, and

the first bulged part is formed by applying a crushing pressure from upward and the second bulged part is formed by applying a crushing pressure from downward.

According to a third invention, there is provided the method for manufacturing the terminals which have the press-fit engaging parts according to the first invention, wherein

the convex bulged parts as the press-fit engaging parts are formed by simultaneously applying crushing pressure on same parts from both upward and downward.

### Advantageous Effects of Invention

According to the first invention, since the press-fit engaging parts are not formed at the time of press punching in the first step, it is possible in this stage to mold the terminals with narrow pitches by making the clearance small. In the following second step, since the crushing pressures are only applied to the prescribed parts of the terminals, a special clearance is unnecessary and the press-fit engaging parts of a shape which has a sufficient projection margin can be simply formed. Therefore, it becomes possible to narrow the pitch of the terminals having the press-fit engaging parts which can secure a required holding force.

According to the second invention, since the crushing pressures are applied from top and bottom, respectively, it is possible to manufacture while balance is further maintained.

According to the third invention, since the crushing pressures are applied from top and bottom on the same parts, the press-fit engaging parts can be easily made by deforming the material.

### BRIEF DESCRIPTION OF DRAWINGS

FIG. 1 is a perspective view which shows a complete state of a molded article that contains terminals manufactured with the method of a first embodiment of the invention.

FIG. 2 is a top view which shows a state after a first step is performed when the terminals are manufactured.

FIG. 3 is a top view which shows a state after a second step is performed following the first step.

FIG. 4 is a perspective view which shows the structure of one of the terminals.

FIG. 5 is a top view which shows the structure of one of the terminals.

FIG. 6 is a side view which shows the structure of one of the terminals.

FIG. 7 is a sectional view which is seen from top and shows that the terminals are going to be collectively press-fitted into a connector housing while the terminals are connected with a carrier.

FIG. 8 is a sectional view which is seen from top and shows that a connector is completed by cutting out the carrier after the terminals of FIG. 7 are press-fitted.

FIG. 9 is a figure which shows the structure of one of the terminals manufactured with the method of a second embodiment of the invention, in which FIG. 9(a) is a top view, FIG. 9(b) is a side view and FIG. 9(c) is an enlarged figure of an area C of FIG. 9(b).

FIG. 10 is a figure which shows the structure of one of the terminals manufactured with the method of a third embodiment of the invention, in which FIG. 10(a) is a top view, FIG. 10(b) is a side view, FIG. 10(c) is a sectional view taken along the line indicated by C-C arrows of FIG. 10(b), and FIG. 10(d) is a sectional view taken along the line indicated by D-D arrows of FIG. 10(b).

FIG. 11 is a figure which shows the structure of one of the terminals manufactured with the method of a fourth embodiment of the invention, in which FIG. 11(a) is a top view, FIG. 11(b) is a side view, FIG. 11(c) is a sectional view taken along the line indicated by C-C arrows of FIG. 11(b), and FIG. 11(d) is a sectional view taken along the line indicated by D-D arrows of FIG. 11(b).

FIG. 12 is a figure which shows the structure of one of the terminals manufactured with the method of a fifth embodiment of the invention, in which FIG. 12(a) is a top view, FIG. 12(b) is a side view, FIG. 12(c) is a sectional view taken along the line indicated by C-C arrows of FIG. 12(b), and FIG. 12(d) is a sectional view taken along the line indicated by D-D arrows of FIG. 12(b).

FIG. 13 is a figure which shows the structure of one of the terminals manufactured with the method of a sixth embodiment of the invention, in which FIG. 13(a) is a top view, FIG. 13(b) is a side view, FIG. 13(c) is a sectional view taken along the line indicated by C-C arrows of FIG. 13(b), and FIG. 13(d) is a sectional view taken along the line indicated by D-D arrows of FIG. 13(b).

FIG. 14 is an explanatory view of a conventional terminal manufacturing method.

### DESCRIPTION OF EMBODIMENTS

Below, the embodiments of the invention are described with reference to the figures.

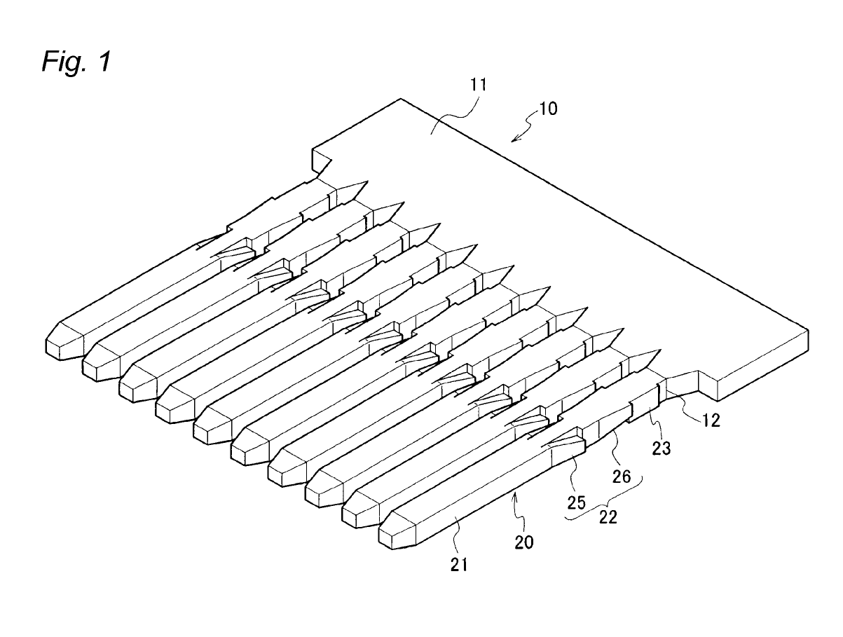

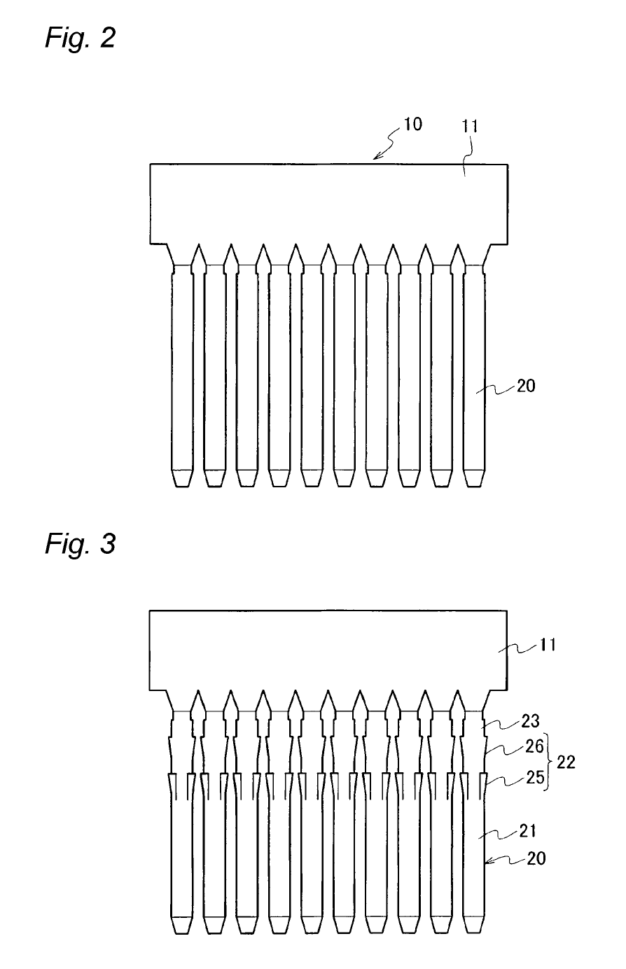

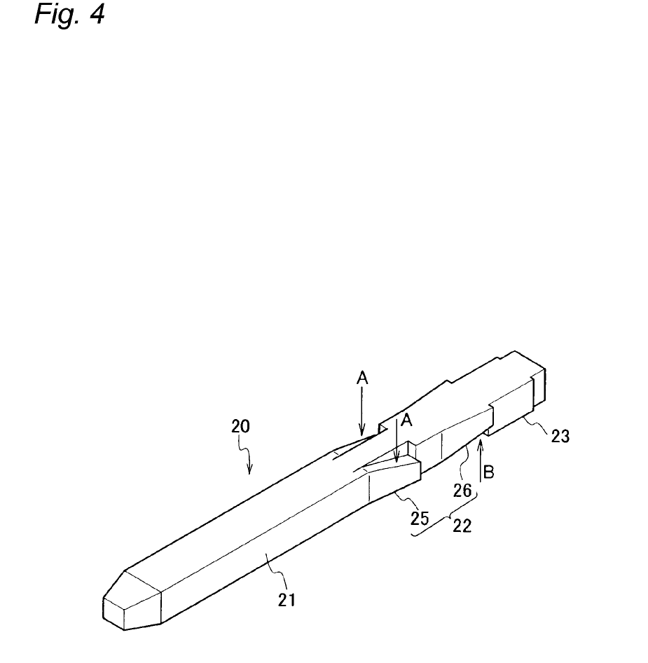

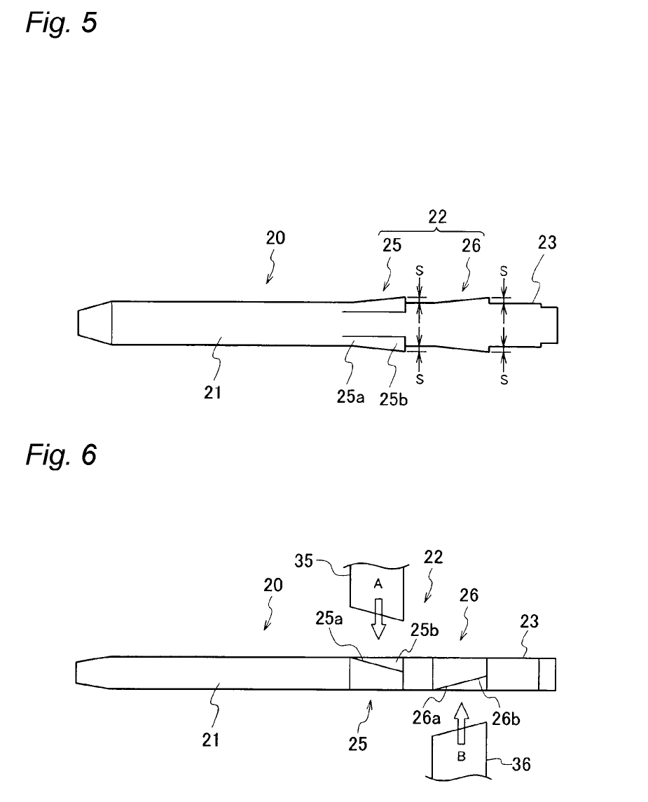

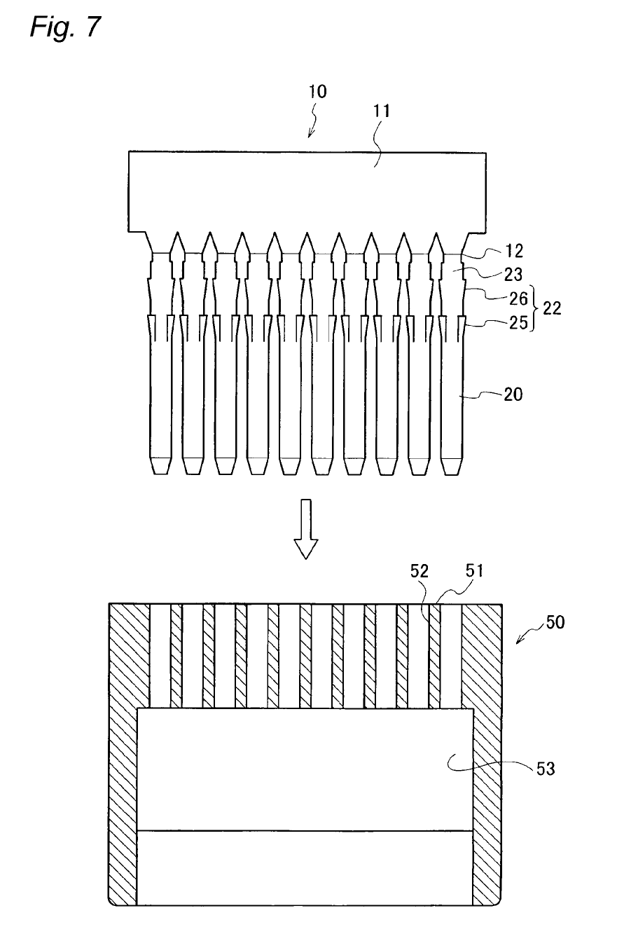

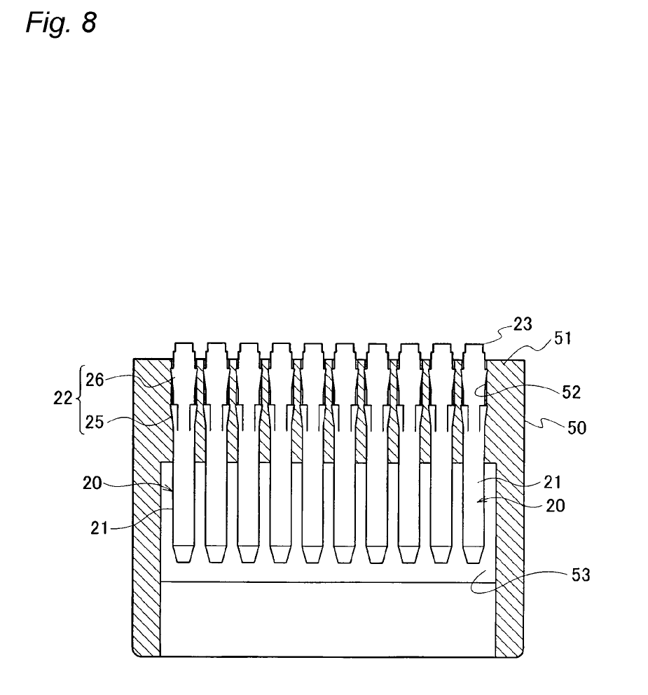

FIG. 1 is a perspective view which shows a complete state of a molded article that contains terminals manufactured with the method of a first embodiment of the invention, FIG. 2 is a top view which shows a state after a first step is performed when the terminals are manufactured, FIG. 3 is a top view which shows a state after a second step is performed following the first step, FIG. 4 is a perspective view which shows the structure of one of the terminals, FIG. 5 is a top view, and FIG. 6 is a side view. FIG. 7 is a sectional view which is seen from top and shows that the terminals are going to be collectively press-fitted into a connector housing while the terminals are connected with a carrier, and FIG. 8 is a sectional view which is seen from top and shows that a connector is completed by cutting out the carrier after the terminals of FIG. 7 are press-fitted.

A molded article 10 which contains a plurality of pin-shaped terminals 20 whose base ends are connected with a carrier 11 is obtained, as finally shown in FIG. 1, with the manufacturing method of the first embodiment. Each of the terminals 20 has an electrical contact part 21, which electrically contacts with a mating connector terminal, at the front, a press-fit engaging part 22, which has a fixing function that prevents the terminal from being pulling out when the terminal is press-fitted into a press-fitting hole of a connector housing, behind the electrical contact part 21, and a hind leg 23 for connecting with a wiring part such as a circuit board behind the press-fit engaging part 22.

When the molded article 10 which contains the plurality of terminals 20 is to be obtained, in an initial first step, first, as shown in FIG. 2, while a plurality of terminals 20 arranged in parallel to each other at a prescribed interval laterally in a row are connected to a carrier 11, the molded article 10 is collectively molded by press punching a sheet metal.

Next, as shown in FIGS. 3 to 6, in a second step, the press-fit engaging parts 22, which prevent the terminals 20 from being pulling out when the terminals 20 are press-fitted into the press-fitting holes of the connector housing, are formed by applying crushing pressures A and B in vertical directions (up and down directions in FIG. 6) that are perpendicular to the direction of arranging the terminals 20 and the longitudinal direction of the terminals 20, onto prescribed parts in the longitudinal direction of the terminals 20, to make the applied points dented and parts at the side surfaces of the terminals to be locally and convexly bulged and deformed sidewards.

In this case, two convex bulged parts 25 and 26 are formed in a row in the longitudinal direction of the terminals 20 as the press-fit engaging parts 22, in which, as shown in FIG. 6, the first bulged part 25 is formed when a crushing pressure A is applied by a pressing mold 35 from top and the second bulged part 26 is formed when a crushing pressure B is applied by a pressing mold 36 from bottom. In this case, the front ends 25a and 26a of the parts which can be dented are crushed lightly, and the back ends 25b and 26b are crushed strongly. Thereby, as shown in FIGS. 4 and 5, since the side surfaces of the terminal 20 are largely bulged sidewards as the parts are crushed strongly, the shape of the bulged parts 25 and 26 becomes a wedge when viewed from top.

When the terminals 20 are manufactured in this way, since the press-fit engaging parts 22 are not formed at the time of press punching in the first step, it is possible in this stage to mold the terminals 20 with narrow pitches by making the clearance between the terminals 20 small. In the following second step, since the crushing pressures A and B are only applied to the prescribed parts of the terminals 20, a special clearance is unnecessary and the press-fit engaging parts 22 of a shape which has a sufficient projection margin S (refer to FIG. 5) can be simply formed. Therefore, it becomes possible to narrow the pitch of the terminals 20 having the press-fit engaging parts 22 which can secure a required holding force. It is possible to reduce the material by narrowing the pitch of the terminals 20. In this embodiment, when the press-fit engaging parts 22 are made, since the crushing pressures A and B are applied from top and bottom, respectively, it is possible to manufacture while balance is maintained.

When the terminals 20 molded in this way are assembled to the connector housing, as shown in FIG. 7, the terminals 20 are press-fitted into the press-fitting holes 52 of the rear wall 51 of the connector housing 50, respectively, while the terminals 20 of the molded article 10 are connected with the carrier 11. Since the press-fit engaging parts 22 whose width is larger than that of the press-fitting holes 52 are pushed into the press-fitting holes 52 and make the hole walls of the press-fitting holes 52 to be transformed, as shown in FIG. 8, the terminals 20 are strongly fixed in the rear wall 51 of the connector housing 50. At this time, the electrical contact parts 21 are accommodated in a hood 53. Thus, after that, a connector can be completed by cutting out the carrier 11 (refer to FIG. 7).

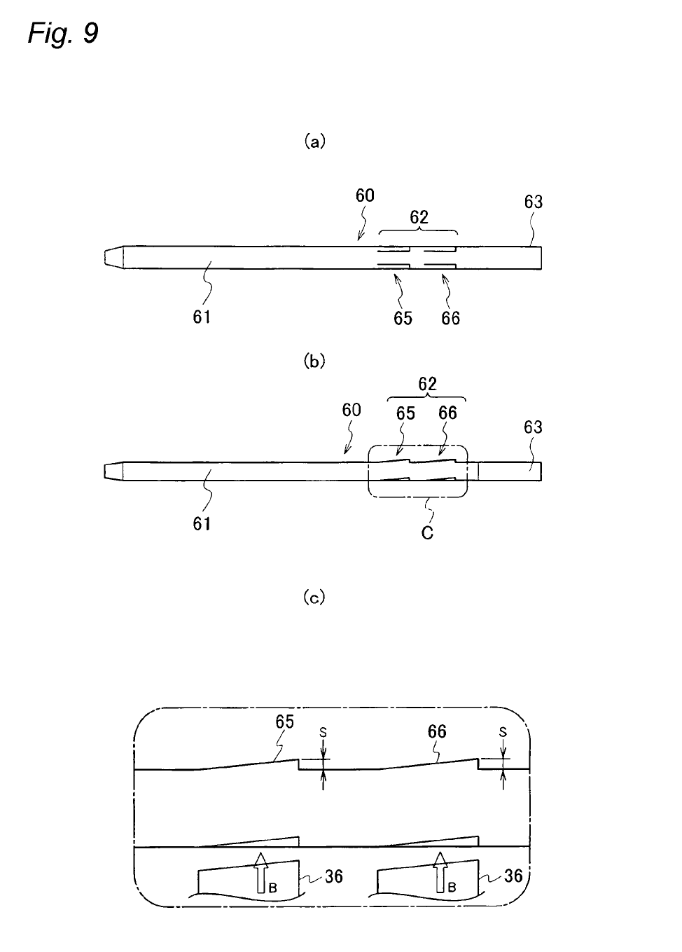

The method of forming the press-fit engaging parts 22 is not limited to the above-mentioned embodiment. FIGS. 9(a) to 13(d) show the structures of terminals 60, 70, 80, 90 and 100 manufactured with the methods of other embodiments.

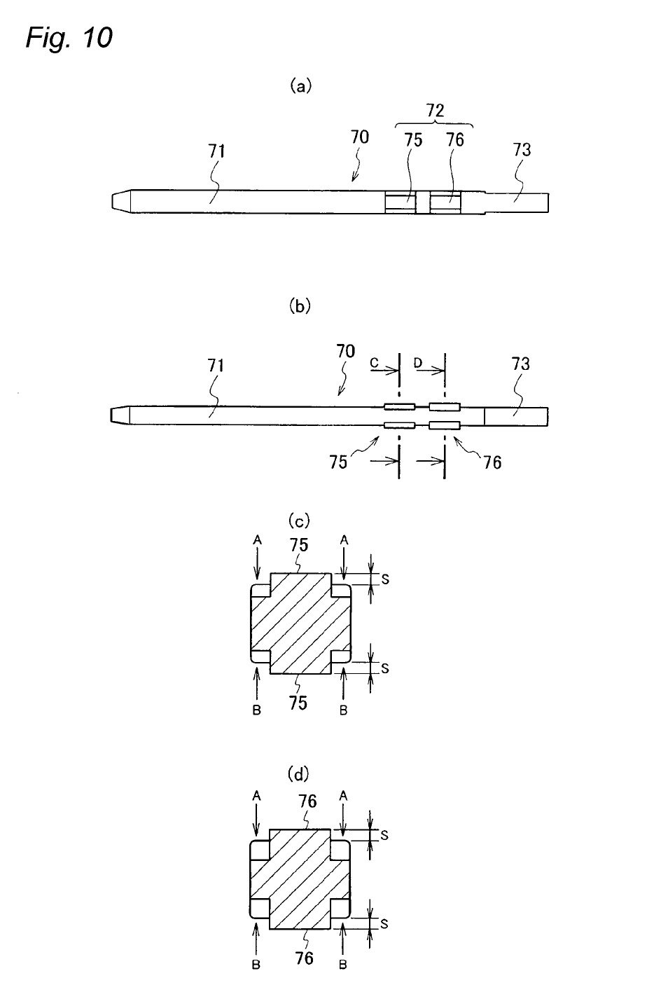

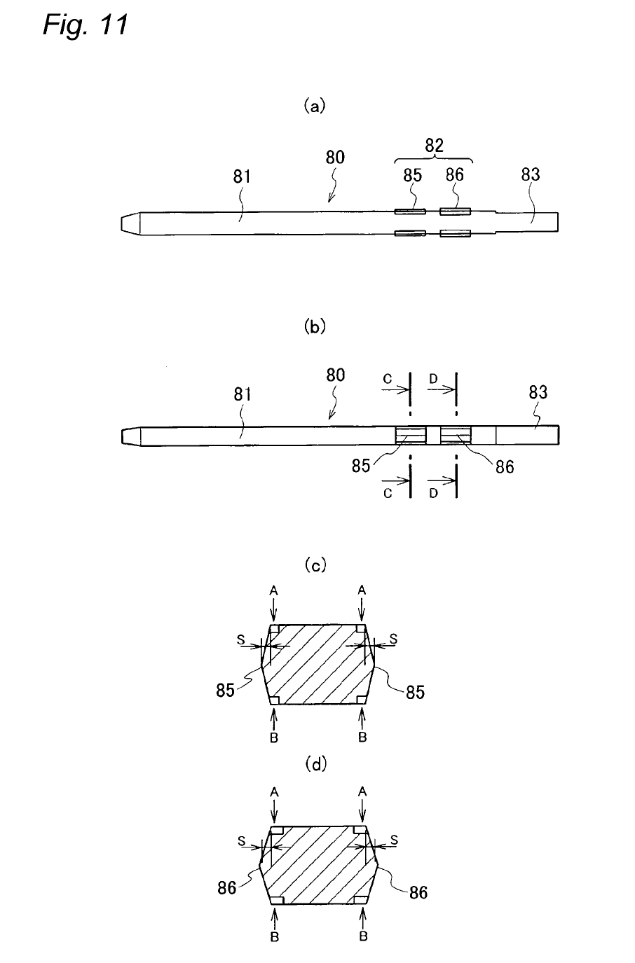

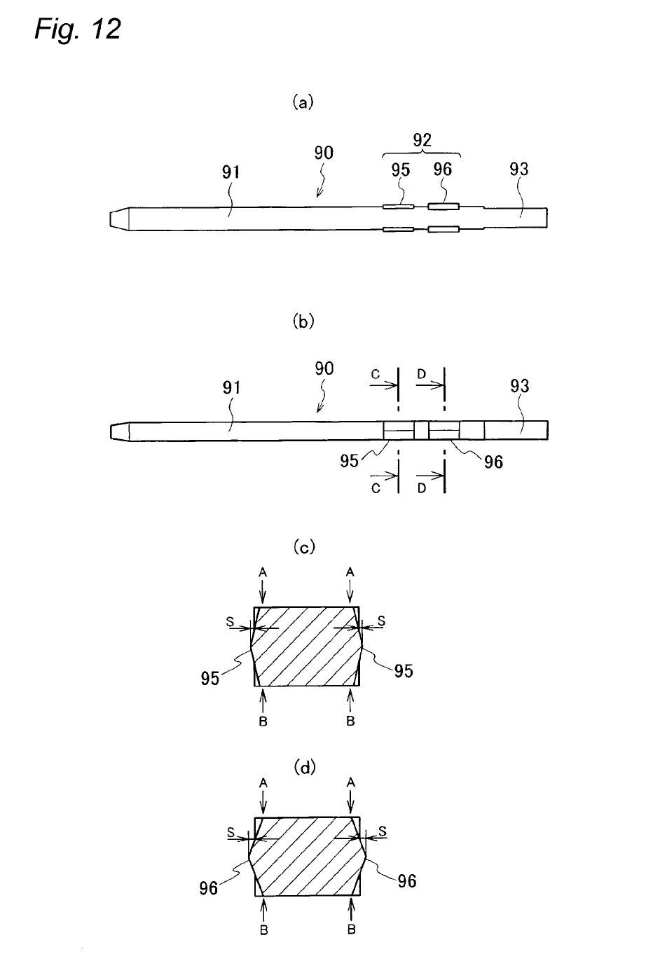

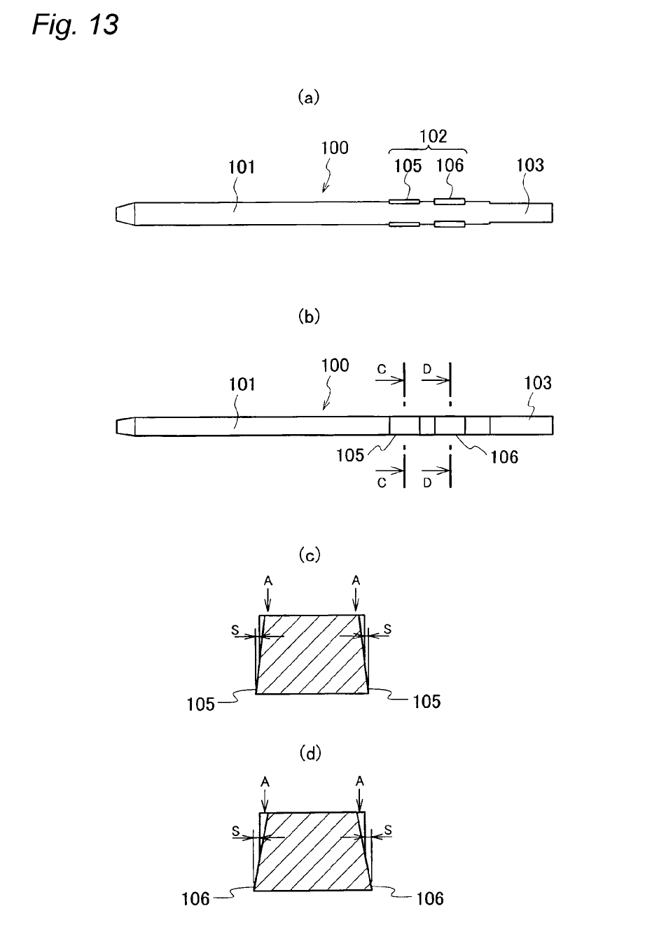

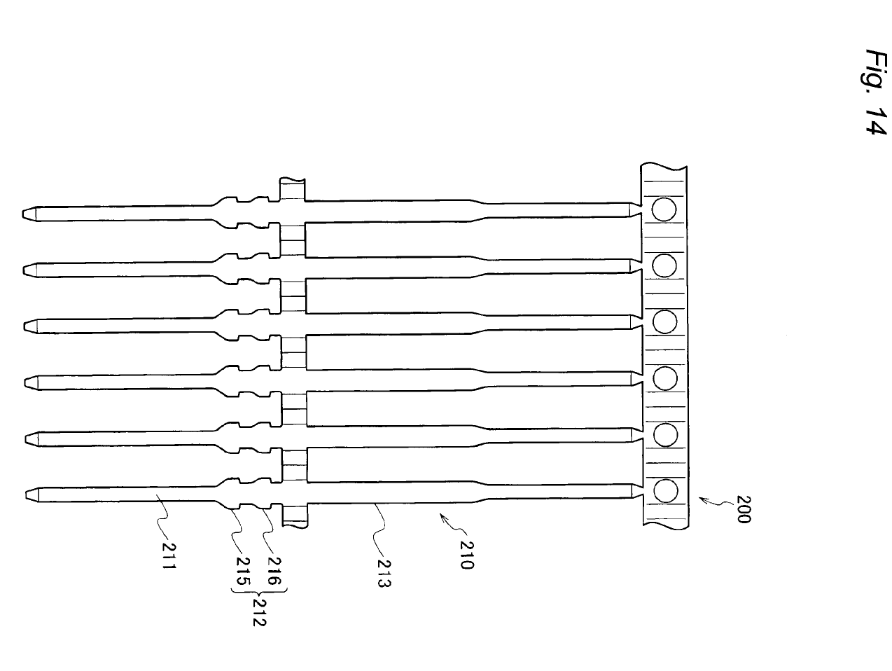

FIGS. 9(a) to 9(c) are figures which show the structure of one of the terminals 60 manufactured with the method of a second embodiment, in which FIG. 9(a) is a top view, FIG. 9(b) is a side view and FIG. 9(c) is an enlarged figure of an area C of FIG. 9(b). FIGS. 10(a) to 10(d) are figures which show the structure of one of the terminals 70 manufactured with the method of a third embodiment, in which FIG. 10(a) is a top view, FIG. 10(b) is a side view, FIG. 10(c) is a sectional view taken along the line indicated by C-C arrows of FIG. 10(b), and FIG. 10(d) is a sectional view taken along the line indicated by D-D arrows of FIG. 10(b). FIGS. 11(a) to 11(d) are figures which show the structure of one of the terminals 80 manufactured with the method of a fourth embodiment, in which FIG. 11(a) is a top view, FIG. 11(b) is a side view, FIG. 11(c) is a sectional view taken along the line indicated by C-C arrows of FIG. 11(b), and FIG. 11(d) is a sectional view taken along the line indicated by D-D arrows of FIG. 11(b). FIGS. 12(a) to 12(d) are figures which show the structure of one of the terminals 90 manufactured with the method of a fifth embodiment, in which FIG. 12(a) is a top view, FIG. 12(b) is a side view, FIG. 12(c) is a sectional view taken along the line indicated by C-C arrows of FIG. 12(b), and FIG. 12(d) is a sectional view taken along the line indicated by D-D arrows of FIG. 12(b). FIGS. 13(a) to 13(d) are figures which show the structure of one of the terminals 100 manufactured with the method of a sixth embodiment, in which FIG. 13(a) is a top view, FIG. 13(b) is a side view, FIG. 13(c) is a sectional view taken along the line indicated by C-C arrows of FIG. 13(b), and FIG. 13(d) is a sectional view taken along the line indicated by D-D arrows of FIG. 13(b).

The parts of the terminals 60, 70, 80, 90 and 100 shown with symbols 61, 71, 81, 91 and 101 are electrical contact parts, the parts shown with symbols 62, 72, 82, 92 and 102 are press-fit engaging parts, and the parts shown with symbols 63, 73, 83, 93 and 103 are hind legs. The press-fit engaging parts, 63, 73, 83, 93 and 103 include two front and back bulged parts 65, 66, 75, 76, 85, 86, 95, 96, 105 and 106 which are protruded sidewards or upwards/downwards with projection margins S from the side surfaces of terminals, respectively.

In the method of the second embodiment shown in FIGS. 9(a) to 9(c), when both upwards crushing pressures B are applied by pressing molds 36 on two ends in the width direction of the bottom surface of the terminal 60, upwards bulged parts 65 and 66 with a projection margin S are formed at two ends in the width direction of the top surface (one surface of the four side surfaces) of the terminal 60.

In the method of the third embodiment shown in FIGS. 10(a) to 10(d), when crushing pressures A and B are simultaneously applied so that corners at the two ends in the width direction of the top surface and the bottom surface of the terminal 70 are dented to form rectangular shapes, bulged parts 75 and 76 with a projection margin S are formed at central parts in the width direction of the top surface and the bottom surface (two surfaces of the four side surfaces) of the terminal 70.

In the method of the fourth embodiment shown in FIGS. 11(a) to 11(d), when crushing pressures A and B are simultaneously applied so that corners at the two ends in the width direction of the top surface and the bottom surface of the terminal 80 are dented to form rectangular shapes, bulged parts 85 and 86, whose projection margin S has a mountain shaped cross section, are formed at the right and left surfaces (two surfaces of the four side surfaces) of the terminal 80.

In the method of the fifth embodiment shown in FIGS. 12(a) to 12(d), when crushing pressures A and B are simultaneously applied so that corners at the two ends in the width direction of the top surface and the bottom surface of the terminal 90 are dented to form triangular shapes, bulged parts 95 and 96, whose projection margin S has a mountain shaped cross section, are formed at the right and left surfaces (two surfaces of the four side surfaces) of the terminal 90. In this case, the size of the projection margin S of the bulged parts 95 and 96 can be changed by changing the crushing pressures applied on the parts which form the front bulged parts 95 and the back bulged parts 96.

In the method of the sixth embodiment shown in FIGS. 13(a) to 13(d), when crushing pressures A are applied so that corners at the two ends in the width direction of the top surface of the terminal 100 are dented to form triangular shapes, bulged parts 105 and 106, whose projection margin S has a mountain shaped cross section, are formed at the lower half parts of the right and left surfaces (two surfaces of the four side surfaces) of the terminal 100. In this case, the size of the projection margin S of the bulged parts 105 and 106 can be changed by changing the crushing pressures applied on the parts which form the front bulged parts 105 and the back bulged parts 106.

Although the present invention is described in detail with reference to the embodiments, it is apparent that various modifications and amendments may be made by those skilled in the art without departing from the spirit and scope of the invention.

This application is based on the Japanese patent application (patent application 2010-022435) filed on Feb. 3, 2010, whose content is incorporated herein by reference.

### REFERENCE SIGNS LIST

11 CARRIER
20 TERMINAL
22 PRESS-FIT ENGAGING PART
25, 26 BULGED PART
50 CONNECTOR HOUSING
52 PRESS-FIT HOLE
60, 70, 80, 90, 100 TERMINAL
62, 72, 82, 92, 102 PRESS-FIT ENGAGING PART
65, 66, 75, 76, 85, 86, 95, 96, 105, 106 BULGED PART
A AND B CRUSHING PRESSURE

1. A method for manufacturing terminals which have press-fit engaging parts comprising:
a first step for collectively forming a plurality of terminals arranged in parallel to each other at an interval laterally in a row in a state connected to a carrier, by press punching a sheet metal; and
a second step for forming the press-fit engaging parts after the first step, by applying crushing pressure in a vertical direction that is perpendicular to an arranging direction of the terminals and a longitudinal direction of the terminals, onto prescribed parts in the longitudinal direction of the terminals so as to make a part of a side surface of each of the terminals to be locally and convexly bulged in at least one direction of side direction and up and down direction, wherein the press-fit engaging parts prevent the terminals from being pulling out when the terminals are press-fitted into press-fitting holes of a connector housing.

2. The method for manufacturing the terminals which have the press-fit engaging parts according to claim 1, wherein
two convex bulged parts are formed in a row in the longitudinal direction of the terminals as the press-fit engaging parts, and
the first bulged part is formed by applying a crushing pressure from upward and the second bulged part is formed by applying a crushing pressure from downward.

3. The method for manufacturing the terminals which have the press-fit engaging parts according to claim 1, wherein
the convex bulged parts as the press-fit engaging parts are formed by simultaneously applying crushing pressure on same parts from both upward and downward.
